(19) United States
(12) Patent Application Publication
(10) Pub. No.: US 2026/0051146 A1
(43) Pub. Date: Feb. 19, 2026

(54) OBJECT TRACKING ACROSS A SEQUENCE OF FRAMES

(71) Applicant: QUALCOMM Incorporated, San Diego, CA (US)

(72) Inventors: Sai Madhuraj JADHAV, Foster City, CA (US); Amin ANSARI, Kirkland, WA (US); Madhumitha SAKTHI, Dublin, CA (US)

(21) Appl. No.: 18/805,396

(22) Filed: Aug. 14, 2024

(51) Int. Cl. G06V 10/62; G06T 7/20; G06V 10/82

(52) U.S. Cl. CPC G06V 10/62; G06T 7/20; G06V 10/82; G06T 2207/10016; G06T 2207/20081; G06T 2207/20084; G06T 2207/30241

(57) ABSTRACT

Certain aspects of the present disclosure provide techniques for performing object detection in a sequence of frames, including: sampling a plurality of frames from the sequence of frames, wherein at least two pairs of frames that are adjacent in time in the plurality of frames are separated by different time intervals; inputting the plurality of frames into a first machine learning model trained to track objects; and obtaining as output from the first machine learning model, based on the input plurality of frames, at least one of an identity or location corresponding to one or more objects in the plurality of frames.

### INTRODUCTION

### Field of the Disclosure

Aspects of the present disclosure relate to object tracking, and more particularly, to techniques for performing object tracking across a sequence of frames.

### Description of Related Art

Object tracking is a task in computer vision with numerous applications, such as surveillance, autonomous vehicles, and robotics. The goal of object tracking is to locate and follow one or more objects of interest across a sequence of frames. This may involve detecting objects in each frame and associating them with their corresponding instances in previous frames to form consistent trajectories over time.

Existing object tracking approaches often process every frame in the sequence of frames to detect and track objects. This exhaustive approach can be computationally expensive, especially for long videos or real-time applications. As the number of frames and objects increases, the computational burden of processing every frame may become prohibitive, limiting the scalability and efficiency of the tracking system.

To address the computational challenge, some techniques employ frame sub-sampling, where only a subset of frames is processed at fixed intervals. For example, every nth frame may be selected for processing, while the remaining frames are skipped. This may reduce the overall computational cost but can lead to suboptimal tracking performance. For example, objects may exhibit significant movements or appearance changes between the sampled frames, making it difficult to accurately track them. Fixed sub-sampling may miss important object motion or interactions that occur in the skipped frames.

### SUMMARY

One aspect provides a method for performing object detection in a sequence of frames. The method includes: sampling a plurality of frames from the sequence of frames, wherein at least two pairs of frames that are adjacent in time in the plurality of frames are separated by different time intervals; inputting the plurality of frames into a first machine learning model trained to track objects; and obtaining as output from the first machine learning model, based on the input plurality of frames, at least one of an identity or location corresponding to one or more objects in the plurality of frames.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an object tracking system in accordance with aspects of the present disclosure.

FIG. 2 depicts additional details of an adaptive sampling technique in accordance with aspects of the present disclosure.

FIG. 3 depicts additional details of an object tracking system that may employ an adaptive sampling technique to track one or more objects across a plurality of frames in accordance with aspects of the present disclosure.

FIG. 4 depicts details of an example process for sampling frames from a distribution and creating a new distribution based on the previously sampled frames in accordance with aspects of the present disclosure.

FIG. 5 illustrates an example artificial intelligence (AI) architecture that may be used for object tracking implementations.

FIG. 6 illustrates an example AI architecture of a first device that is in communication with a second device.

FIG. 7 illustrates an example artificial neural network.

FIG. 8 depicts an example method for performing object detection in a sequence of frames.

FIG. 9 depicts aspects of an example processing system in accordance with aspects of the present disclosure.

### DETAILED DESCRIPTION

Aspects of the present disclosure provide apparatuses, methods, processing systems, and computer-readable mediums for performing object detection in a sequence of frames by non-uniformly sampling frames from the sequence of frames. Non-uniform frame sampling may refer to sampling frames at a non-fixed interval, such that the time interval between one pair of the sampled frames is different than the time interval between at least one other pair of the sampled frames. For example, assuming an initial set of frames at times t=1s, 2s, 3s, 4s, 5s, 6s, 7s; a non-uniform sampling could be 1, 2, 4, 6, where there are different intervals between samples, such as 1s, 2s, and 2s

Tracking objects across a video sequence involves detecting and locating objects of interest in each frame and then associating those detections over time to form consistent object trajectories. This process typically requires applying object detection algorithms to each frame to identify and localize objects, extracting relevant features or appearance information from the detected objects, and then using those features to match and link the objects across subsequent frames. As the length of the video sequence increases, the number of frames that need to be processed grows proportionally, leading to an increase in computational complexity and processing time. For example, tracking objects in a video sequence with thousands of frames would require applying the object detection and association steps to each of those frames, resulting in a large number of computations and a high computational burden, especially if the tracking needs to be performed in real-time or with limited computational resources. Thus, processing every frame to detect and track objects is often infeasible in real-time applications. Sub-sampling frames at a fixed interval can reduce computation but may miss important object movements between the sampled frames.

Techniques described herein may address these shortcomings by non-uniformly sampling frames from a sequence of frames at varying time intervals. In certain aspects, the non-uniform sampling of frames may be performed randomly (e.g., using a random number generator). In certain aspects, the non-uniform sampling of frames may be performed based on a fixed function (e.g., a non-linear function).

In certain aspects, the non-uniform sampling of frames may be performed using adaptive sampling. For example, in certain aspects, techniques described herein may involve selecting a subset of frames to process based on the expected motion of objects, rather than processing every frame or using a fixed sampling interval. This may be achieved by iteratively updating a multimodal sampling distribution that assigns higher probabilities to frames likely to contain significant object motion. The sampled frames may then be input to an object tracking model to detect and track objects through the sequence of frames. By focusing computational resources on the more informative frames, the adaptive sampling approach enables accurate object tracking while reducing the overall computational burden.

In certain aspects, multiple different sampling techniques may be used to select a subset of frames, such as including one or more of the non-uniform sampling techniques discussed herein, such as random sampling, fixed function sampling, or adaptive sampling. In certain aspects, the one or more non-uniform sampling techniques may be used along with one or more other techniques (e.g., uniform sampling techniques) to select a subset of frames, with the resulting subset still having some non-uniformity in intervals between adjacent frames in time. Adjacent frames in time in the subset may mean a pair of frames for which there is no intervening frame in time between the pair of frames in the subset of frames.

In certain aspects, by choosing which frames to process, sampling according to the techniques described herein enables object tracking while reducing the total number of frames that need to be analyzed by an object tracking system. Certain aspects may improve computational efficiency, allowing tracking on longer videos in real-time, and may reduce processing resources and power consumed by an object tracking system. In certain aspects, the use of varying sampling intervals can also provide more temporally consistent object tracks, such as by adjusting the frame rate to the object motion, or statistically accounting for potential changes in the rate of the object motion. For example, the use of varying sampling intervals may be useful for tracking long tailed events and/or to account for diverse camera motion. Long tailed events are events that are rare in occurrence, and hence do not have many training samples in the dataset. Some examples include motorcycle maneuvers, large trucks with unstable detection, slow horse carriages, pedestrian crossings, etc. Diverse camera motion may be caused by a low frame rate during online tracking, or during the occurrence of unique motion caused by ramps, bumps, etc.

In certain aspects, the incorporation of adaptive frame weights based on feature analysis, object detection confidence, and motion saliency promotes frame selection that is not limited by fixed sampling intervals. Thus, in certain aspects, the techniques described herein may advance the field of object tracking by enabling efficient frame processing customized to object motion.

### Aspects Related to Performing Object Detection

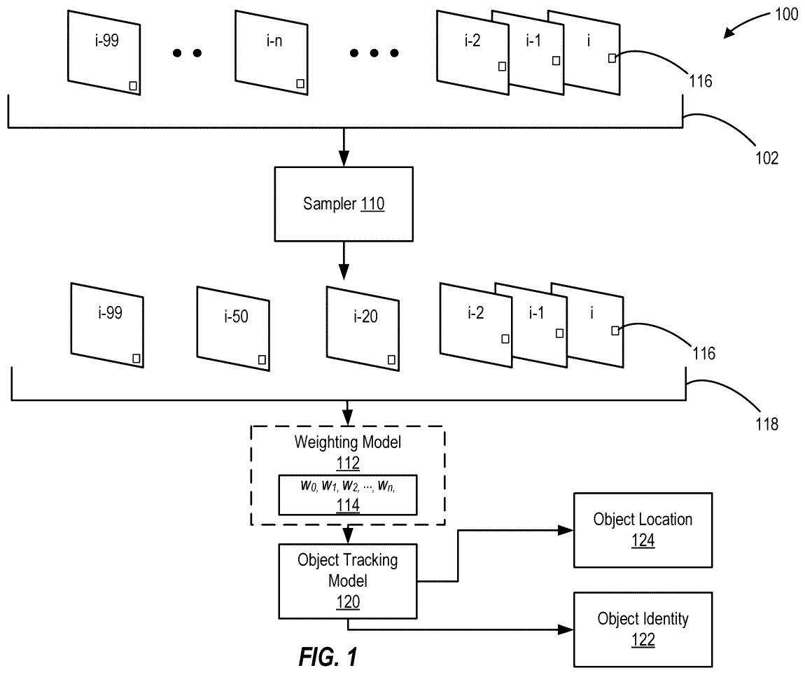

FIG. 1 depicts an object tracking system 100 in accordance with aspects of the present disclosure. In some aspects, the object tracking system 100 may include an object tracking model 120, where the object tracking model 120 may output an object identity 122 (e.g., an identifier of the object) and/or an object location 124 (e.g., a position of the object, such as within the frame) based on at least some of the plurality of frames 102 being input into the object tracking model 120. For example, in some aspects, the object tracking system 100 may be used to track an object 116 across the plurality of frames 102. In some aspects, the object 116 may be any object of interest within the plurality of frames 102, such as a person, vehicle, or other moving or stationary object.

In some aspects, the plurality of frames 102 may be frames stored in a frame buffer, such as frames i to i-99, where i may represent the most recent frame, and i-n represents a frame that is n frames (e.g., n time intervals) prior to the most recent frame. For example, the object tracking may be performed on a moving window of frames including the N most recent frames, such that the frame buffer holds N frames.

In certain aspects, the plurality of frames 102 may be obtained from one or more sources and/or modalities. In some examples, the plurality of frames 102 may be acquired using one or more image sensors, such as camera(s), that capture a sequence of 2D images over time. These camera(s) can include, but are not limited to, RGB camera(s), infrared camera(s), or any other type of imaging device capable of capturing an image. In some aspects, the frames can be extracted from a video stream, such as at a specified frame rate, allowing for the analysis of object movement and behavior across time.

In certain aspects, the frames may be obtained using depth sensor(s), such as LiDAR (Light Detection and Ranging) or time-of-flight camera(s). Such sensor(s) may provide 3D point cloud data, where each point represents the distance of an object from the sensor. In some aspects, LiDAR systems emit laser pulses and measure the time it takes for the pulses to reflect back from objects in the environment. By combining the distance measurements with the angular information of the laser beams, a 3D representation of the scene can be constructed. The resulting frames may contain depth information, enabling the object tracking system 100 to perform 3D object localization and tracking.

In some examples, the frames 102 may be obtained from a combination of multiple sensors, such as a fusion of RGB camera(s) and LiDAR sensor(s). In some aspects, a multi-modal approach may leverage complementary information provided by different sensors to enhance the accuracy and robustness of object tracking. The RGB camera(s) may capture rich visual information, including object appearance and texture, while the LiDAR sensor(s) may provide precise depth measurements. In certain aspects, by aligning and synchronizing the data from these sensors, the object tracking system 100 may obtain a comprehensive representation of the scene, benefiting from both visual and geometric cues.

In certain aspects, the frames can be stored in a frame buffer, allowing for efficient access and retrieval during the object tracking process. The frame buffer may be implemented as a circular buffer, where the oldest frames are replaced by the newest frames once the buffer reaches its maximum capacity. In certain aspects, a frame buffer may enable the object tracking system 100 to maintain a sliding window of frames, providing temporal context for object tracking.

In certain aspects, the plurality of frames 102 may include frames corresponding to a fixed interval in time, such that adjacent frames of the plurality of frames 102 are all separated by the same fixed interval in time. In some aspects, the frame rate at which the frames may be obtained may vary depending on the specific application and system requirements. In some examples, the frame rate may be high, such as 30 or 60 frames per second, to capture fast-moving objects and enable smooth tracking. In other cases, a lower frame rate may be sufficient, especially when dealing with slower-moving objects or when computational resources are limited.

In certain aspects, the plurality of frames 102 may be sampled according to one or more techniques as discussed further herein, such as non-uniformly sampled, to generate a plurality of sampled frames 118. For example, a sampler 110 may be configured to take as input the plurality of frames 102, and output the plurality of sampled frames 118. The plurality of sampled frames 118 may be a subset of the plurality of frames 102, in that it includes less frames than the plurality of frames 102. In certain aspects, the plurality of sampled frames 118 may have at least some non-uniformity, in that at least one pair of adjacent frames in the plurality of sampled frames 118 are separated by a different time interval than at least one other pair of adjacent frames in the plurality of sampled frames 118.

In some aspects, the plurality of sampled frames 118 are input into object tracking model 120. Object tracking model 120, accordingly, is configured to output an object identity 122 and/or an object location 124 for each of one or more objects, such as object 116, based on the plurality of sampled frames 118 being input into the object tracking model 120.

In some aspects, one or more frames may be pre-processed before being input into the object tracking model 120. In some aspects, the pre-processing steps may include resizing the frames to a consistent resolution, normalizing the pixel values, or applying image enhancement techniques to improve the quality and clarity of the frames. Additionally, the one or more frames may undergo geometric transformations, such as calibration and rectification, to ensure accurate spatial alignment between consecutive frames and across different sensors. For example, the one or more frames may be the plurality of frames 102 which are pre-processed, and then the pre-processed frames are sampled to generate the plurality of sampled frames 118. In another example, all of the plurality of frames 102 are not pre-processed, as in the plurality of frames 102 are sampled to generate the plurality of sampled frames 118, which are then pre-processed. Pre-processed in this context may mean processed before input into the object tracking model 120.

In some aspects, the object tracking model 120 may be configured to process the input frames and generate an object identity 122 and/or an object location 124 for each tracked object as outputs. In certain aspects, the object tracking model 120 can be implemented using one or more of various approaches, ranging from traditional computer vision techniques to deep learning-based methods. In certain aspects, the object tracking model 120 may employ one or more computer vision algorithms, such as feature-based tracking or template matching. These methods may rely on extracting distinctive features from the objects, such as corners, edges, or texture patterns, and tracking them across consecutive frames. The object tracking model 120 may use one or more techniques like optical flow, which estimates the motion of pixels between frames, to determine the object's movement and update its location. In some aspects, the object tracking model 120 may implement one or more deep learning-based approaches to track one or more objects across a sequence of frames. One or more deep learning models, such as a convolutional neural networks (CNN) or recurrent neural network (RNN), can be used to learn rich feature representations from the input frames, capturing both spatial and temporal dependencies. A deep learning model may be trained on large datasets of annotated frames, allowing it to learn patterns and characteristics of objects in various contexts.

An example deep learning-based approach for object tracking may include the Siamese network architecture. In this approach, the object tracking model 120 may include two identical CNN branches that share weights. In examples, the object tracking model 120 may take a pair of frames as input, where one frame contains the object of interest, and the other frame is a search region in the subsequent frame. In such an example, the object tracking model 120 may learn to compare the features extracted from both frames and generate a similarity map indicating the likelihood of the object's presence at each location in the search region. By performing this comparison across consecutive frames (which may be separated non-uniformly), the object tracking model 120 can track the object's movement and update its location.

As another example, one or more other deep learning-based approaches, such as YOLO (You Only Look Once) or Faster R-CNN, in combination with one or more tracking algorithms may be used by the object tracking model 120. In this example approach, the object tracking model 120 may first apply an object detection model to each frame independently to detect and localize objects. The detected object(s) may then be associated across frames using tracking algorithms, such as the Hungarian algorithm or the Kalman filter, which consider the objects'motion and appearance similarity to establish their identities and trajectories.

In certain aspects, the object tracking model 120 may also incorporate one or more attention mechanisms, which may allow the object tracking model 120 to focus on the (e.g., most) relevant region(s) or feature(s) of the input frames. An attention mechanism can help the model handle occlusions, clutter, or distractors by dynamically assigning higher importance to the informative parts of the frames while suppressing irrelevant information. In certain aspects, the selective attention can enable the object tracking model 120 to maintain robust tracking performance even in challenging scenarios.

In certain aspects, the object tracking model 120 may additionally or alternatively leverage temporal information to improve tracking accuracy and consistency. One or more recurrent neural networks, such as Long Short-Term Memory (LSTM) or Gated Recurrent Units (GRU), may be used to model the temporal dependencies between frames. These recurrent architecture(s) may allow the object tracking model 120 to capture the object's motion patterns and dynamics over time, enabling more accurate and smooth tracking results.

In some examples, the object tracking model 120 may be first trained on one or more large-scale datasets and then fine-tuned on specific domain data to adapt to the characteristics and challenges of the target application. One or more transfer learning techniques can be employed to leverage the knowledge learned from related tasks, such as object detection or segmentation, to improve the tracking performance and reduce the training time.

As an example, an object location 124 output by the object tracking model 120 may represent the spatial position or coordinates of the object 116 within each frame. The object location 124 may be used in multi-object tracking, as it may allow the system to determine the precise location and movement of object 116 across the frames.

In some examples, the object location 124 may be represented using one or more bounding boxes. A bounding box may refer to a rectangular region that encloses the object of interest within a frame. The bounding box may be defined by its top-left and bottom-right coordinates or by its center coordinates along with its width and height. In certain aspects, the object tracking model 120 may predict the bounding box for each object in each frame, providing a compact representation of the object's spatial extent.

In certain aspects, the object location 124 may alternatively or additionally include information other than the bounding box coordinates. For example, the object location 124 may include the object's center point, which may represent the centroid of the object within the frame. The center point may be used for tracking the object's trajectory over time and for performing distance-based calculations between objects. In certain aspects, the object location 124 may include the object's orientation or pose information, indicating the direction or angle at which the object is facing within the frame.

In certain aspects, the object identity 122 represents a unique identifier assigned to the object 116 being tracked, such as allowing the object tracking system 100 to distinguish between multiple objects across the frames.

In certain aspects, each of the plurality of sampled frames 118 may be associated with a respective weight. In certain aspects, weights of a higher value may be assigned to frames that contain more important information, such as frames with significant object motion, appearance changes, or distinctive features. In certain aspects, weights of a lower value may be assigned to frames that correspond to redundant or less informative frames that can be sampled less frequently without compromising tracking performance. In certain aspects, the weighted frames reflect the importance of each frame based on the assigned weights.

For example, the object tracking system 100 may further include a weighting model 112 configured to take as input the plurality of sampled frames 118, and generate weights 114 for each of the plurality of sampled frames 118. In some aspects, the weighting model 112 may be implemented using one or more techniques, such as self-attention mechanism(s), learning-based approach(es), or heuristic method(s) that consider factors like motion, appearance, or saliency. In some aspects, the weighting model 112 may learn the weights 114 dynamically during a training process of the object tracking system 100.

For example, the weighting model 112 may learn the weights 114 for the sampled frames 118 dynamically during a training process of the object tracking system 100. In certain aspects, the training process may include providing a training dataset including a plurality of training sequences, each training sequence comprising a plurality of frames. The training sequences may be annotated with ground truth object identities and locations for one or more objects appearing in the frames. In some aspects, the training process may include, for each training sequence: sampling frames 118 from the sequence using the sampler 110; inputting the sampled frames 118 into the weighting model 112; generating a weight 114 for each of the sampled frames using the weighting model 112, for example using a self-attention mechanism that determines the relative importance of each frame; inputting the sampled frames 118 and their corresponding weights 114 into the object tracking model 120; outputting, by the object tracking model 120, predicted object identities 122 and object locations 124 for the sampled frames; and calculating a loss function that compares the predicted object identities and locations to the ground truth annotations.

In some aspects, the loss may be backpropagated through the object tracking model 120 and weighting model 112 to update their parameters. The above sequence of steps may be repeated for a number of training iterations until convergence. Through this training process, the weighting model 112 may learn to assign weights to the sampled frames to improve the performance of the object tracking model 120. The self-attention mechanism may allow the weighting model 112 to learn which frames are most informative for the object tracking task based on the loss feedback from the object tracking model 120. After sufficient training, the weighting model 112 may be used to generate weights for new unseen sequences at inference time.

In certain aspects, the object tracking model 120 is configured to utilize the weights to emphasize the contribution of higher weighted frames and attenuate the influence of lower weighted frames, thereby potentially improving object tracking accuracy. For example, the object tracking model 120 may be configured to receive the weights 114 from the weighting model 112, and may weight the plurality of sampled frames 118 accordingly. In another example, the weighting model 112 may be configured to apply the weights 114 to the plurality of sampled frames 118 to generate weighted frames, which are sent to the object tracking model 120. For example, one or more values (e.g., feature values, pixel values, embedding values, etc.) of the plurality of sampled frames 118 may be modified by the respective weights 114, where the values may depend on the architecture of the object tracking system 100. In certain aspects, weighting model 112 or object tracking model 120 may perform element-wise multiplication of the plurality of sampled frames 118 (e.g., of the values of the plurality of sampled frames 118) with their corresponding weights 114, as discussed further herein.

For example, if F=[f₁, f₂, . . . , fₙ] denotes the feature representations of the sampled frames, and W=[w₁, w₂, . . . , wₙ] denotes their corresponding weights, the weighted feature representations F_{weighted} can be obtained as: F_{weighted}=[w₁*f₁, w₂*f₂, . . . , wₙ*fₙ], where * represents element-wise multiplication. In certain aspects, the object tracking model 120 may then process the weighted feature representations F_{weighted} using its tracking algorithm, such as a deep neural network or a Bayesian filtering method, to estimate the object identities 122 and object locations 124 in the sampled frames. By operating on the weighted features, the tracking algorithm may prioritize the information from the most relevant frames according to the weights, leading to potentially improved tracking accuracy.

As another example, the object tracking model 120 may adopt an attention mechanism that uses the weights 114 to compute a weighted sum of the features from different frames. This may allow the model to focus on the most informative regions across the sampled frames for object tracking. The attention mechanism may be implemented as: F_{attended}=sum(aᵢ*fᵢ) for i=1 to n, where aᵢ=softmax(wᵢ) are the attention coefficients derived from the weights, and sum( ) denotes a summation operation. The attended features F_{attended} may then be fed into subsequent layers of the object tracking model 120 to predict the object identities and locations.

In certain aspects, by utilizing the weights as described above, the object tracking model 120 may utilize the most informative frames and regions for accurate object tracking, while reducing the impact of less relevant frames.

In some aspects, the weights 114 may represent the importance or relevance of each frame for the object tracking task. In some aspects, the weighting model 112 may assign higher weights to frames that contain significant object motion, appearance variations, or critical events, while assigning lower weights to less informative frames. In some examples, the weighting model 112 may be implemented using one or more of various techniques, such as deep learning architecture(s), attention mechanism(s), or statistical model(s). The choice of weighting model may depend on the specific requirements of the application, the complexity of the scene, and the available computational resources. The weighting model 112 may be trained on a dataset of annotated frames to learn the optimal weights for different scenarios and object types.

In certain aspects, the weighting model 112 uses attention mechanism(s), such as self-attention, to determine the weights for each frame. An attention mechanism may capture the dependencies and relationships between different frames and regions within the frames. In the context of object tracking, self-attention may allow the weighting model 112 to attend to different parts of the input frames and assign weights based on their relevance to the object being tracked. In some aspects, the self-attention mechanism may compute attention scores between different frames or regions within the frames, indicating how much each frame or region should attend to the others. This allows the weighting model 112 to capture long-range dependencies and focus on the most informative parts of the input frames.

In some aspects, the self-attention mechanism in the weighting model 112 works as follows. Each frame in the plurality of sampled frames 118 may be first embedded into a high-dimensional feature space using an embedding function, such as a convolutional neural network. This embedding may capture the spatial and temporal information of the frames. For each frame, three different linear transformations may be applied to the embedded features to compute the query, key, and value vectors. The query vector represents the current frame being processed, while the key and value vectors represent the other frames in the sequence. Attention scores can be computed by taking the dot product between the query vector of the current frame and the key vectors of all the frames in the sequence. These scores may indicate the importance of each frame with respect to the current frame. The attention scores can then be passed through a function, such as a softmax function, to obtain the attention weights. The softmax function may normalize the scores and ensures that the weights sum up to 1. These weights may represent the importance of each frame in relation to the current frame.

In some aspects, the attention weights may be used to compute a weighted sum of the value vectors of all the frames in the sequence. This weighted sum may represent the attended features for the current frame, emphasizing the most relevant information from the other frames. The attended features for each frame may then passed through one or more additional layers, such as a feedforward neural network, to generate the weights 114 for the plurality of sampled frames 118.

By using self-attention, the weighting model 112 may capture the dependencies and relationships between different frames and regions, focusing on the most informative parts of the input frames for object tracking.

In some aspects, the weighting model 112 offers several advantages over traditional weighting approaches. In certain aspects, the weighting model can capture long-range dependencies and adapt to different object appearances and motion patterns. In certain aspects, a self-attention mechanism may allow the model to attend to relevant information across the entire sequence of frames, enabling more accurate and robust tracking.

Accordingly, the object tracking model 120 may be configured to track object(s) across the frames 102, such as based on the sampled frames 118. As discussed, in certain aspects the plurality of frames 102 may be non-uniformly sampled to generate the plurality of sampled frames 118, such as by sampler 110. Such non-uniform sampling may reduce the computations and memory required to be performed by object tracking model 120, by reducing the number of frames input into the object tracking model 120 for object tracking. Further, such non-uniform sampling may help account for potential changes in the rate of object motion, and capture potential abrupt object movement that may not be captured where the frames 102 are sampled uniformly. For example, if the abrupt movement happens in a time span that is less than a fixed interval for sampling, then uniformly sampling frames 102 may not capture such abrupt movement. However, non-uniform sampling may have a chance of capturing such abrupt movement, as some frames may be captured with an interval small enough to capture such movement. Accordingly, in certain aspects, techniques for such non-uniform sampling are provided herein.

In certain aspects, a non-uniform sampling technique includes random sampling of the frames 102 to generate the plurality of sampled frames 118. For example, a random number generator or other randomization algorithm, may be used to randomly select a number of frames (e.g., configured number of frames, percentage of frames, etc.) from the frames 102. The resulting plurality of sampled frames 118 would therefore have some non-uniformity attributable to the random selection.

In certain aspects, a non-uniform sampling technique includes a fixed function used for sampling of the frames 102 to generate the plurality of sampled frames 118. For example, a non-linear function, such as based on (e.g., a combination or function of) one or more of a logarithmic, square root, or reciprocal function, etc., may be used to select the frames. In certain aspects, a logarithmic, square root, or reciprocal function may result in denser sampling between recent frames and sparser sampling further back in time, thereby focusing on more recent movements of objects for tracking in certain aspects. The resulting plurality of sampled frames 118 would therefore have some non-uniformity attributable to the fixed function. For example, if the fixed function is the square root, and the original frames 102 are frame numbers 1-100, then the plurality of sampled frames 118 may include frame numbers 1 (sqrt(1)=1); 4 (sqrt(4)=2), 9 (sqrt(9)=3), etc.

In certain aspects, a non-uniform sampling technique includes an adaptive sampling technique as further discussed herein. For example, in certain aspects, techniques described herein may involve selecting the plurality of sampled frames 118 to process based on the expected motion of objects (e.g., object 116). This may be achieved by iteratively updating a (e.g., multimodal) sampling distribution that assigns higher probabilities to frames likely to contain significant object motion. By focusing computational resources on the more informative frames, the adaptive sampling approach enables accurate object tracking while reducing the overall computational burden. In certain aspects, adaptive sampling may be performed manually.

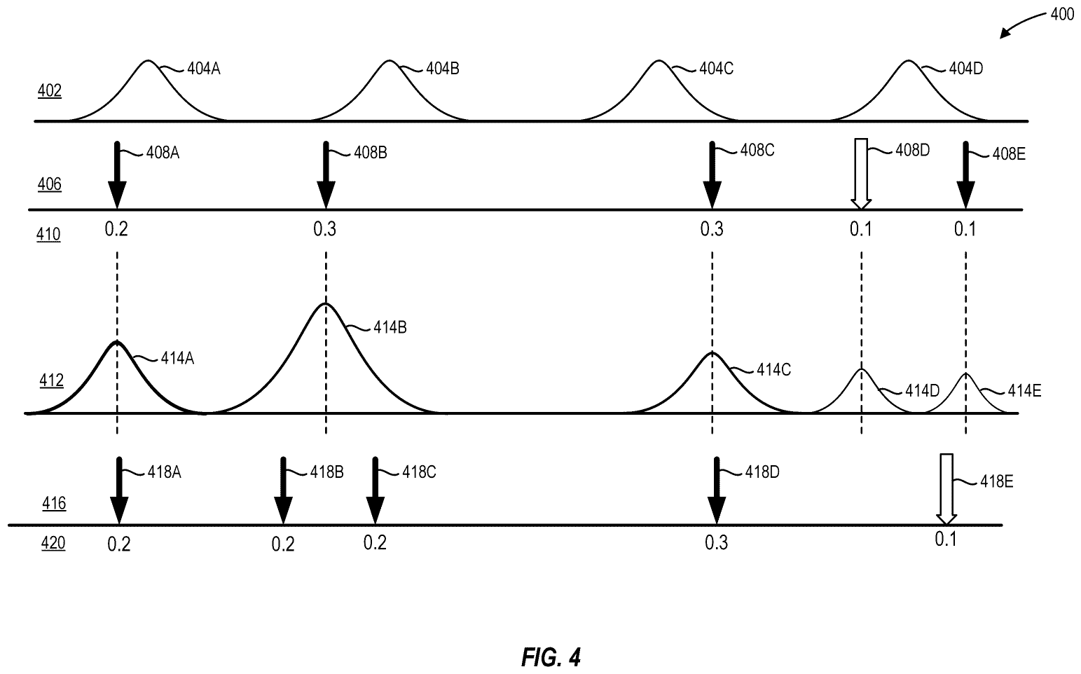

In certain aspects adaptive sampling may be performed using a self-attention based sampling strategy, where a weighting model (e.g., machine learning model, algorithm, etc.) learns weights to give to samples (e.g., frames) (e.g., dynamically on the fly). The weights may be used to form a (e.g., multimodal) Gaussian distribution, wherein the variance of the different Gaussians is proportional to the weights. The distribution may be used to sample the frames, as further discussed herein with respect to FIG. 4 as an example.

In certain aspects, multiple different sampling techniques may be used to select the plurality of sampled frames 118 from the plurality of frames 102, such as including one or more of the non-uniform sampling techniques discussed herein, such as random sampling, fixed function sampling, or adaptive sampling. In certain aspects, the one or more non-uniform sampling techniques may be used along with one or more other techniques (e.g., uniform sampling techniques) to select a subset of frames, with the resulting subset still having some non-uniformity in intervals between adjacent frames in time. For example, each of the multiple different sampling techniques may be used to select a different portion or subset of the plurality of sampled frames 118 from the plurality of frames 102.

An example of a sampling technique that may be a uniform sampling technique may include a nearest neighbor sampling, whereby the latest n frames in time of the plurality of frames 102 are sampled to be included in the plurality of sampled frames 118.

An example of another sampling technique that may be a uniform sampling technique may include a fixed interval sampling, whereby frames are uniformly selected according to a specific stride, such that the frames are separated by a fixed time interval. For example, if the stride (e.g., fixed time interval) is the 3, and the original frames 102 are frame numbers 1-100, then the plurality of sampled frames 118 may include frame numbers 1, 4, 7, 10, 13, etc.

In certain aspects, sampler 110 may comprise a machine learning model, such as a deep neural network, trained to perform sampling according to one or more sampling techniques discussed herein. In certain aspects, a training process for the sampler 110 may include preparing a training dataset comprising a plurality of video sequences, each sequence containing a series of frames, where the video sequences may cover various scenarios, object types, and challenging conditions to ensure a diverse and representative training set. The training process may include defining a loss function that measures the quality of the sampling performed by the sampler 110, where the loss function may consider factors such as the temporal coverage of the sampled frames, the presence of key objects or events, and the diversity of the sampled frames. The training process may include initializing one or more parameters of the sampler 110, such as the weights of the neural network layers, using random or pre-trained values. The training process may include iterating through the training dataset, by performing the following steps for each video sequence: feeding the video sequence into the sampler 110; generating, by the sampler 110, a set of sampled frames based on its current parameters; evaluating the quality of the sampled frames using the defined loss function; computing the gradients of the loss function with respect to the model parameters using techniques such as backpropagation; and updating the one or more model parameters using an optimization algorithm, such as but not limited to, stochastic gradient descent (SGD) or Adam, to minimize the loss function. The training process may iterate through the training dataset for multiple epochs until the sampler 110 converges or reaches a satisfactory performance level.

Once trained, the sampler 110 may be deployed as part of the object tracking system 100 to perform sampling on new, unseen video sequences. The trained model may take an input video sequence and apply the learned sampling strategies to select a subset of frames that best represent the objects and events of interest. This sampled subset of frames may then be passed to other stages of the object tracking pipeline, such as the weighting model 112 and the object tracking model 120, for further processing and analysis.

By employing a machine learning approach, the sampler 110 can adapt to various domains, object types, and challenging conditions, enabling robust and efficient object tracking in real-world scenarios. In certain aspects, sampler 110 may comprise a circuit or software component configured to run on a processor. In certain aspects, sampler 110 may be implemented as a function or algorithm.

### Aspects Related to Performing Adaptive Sampling

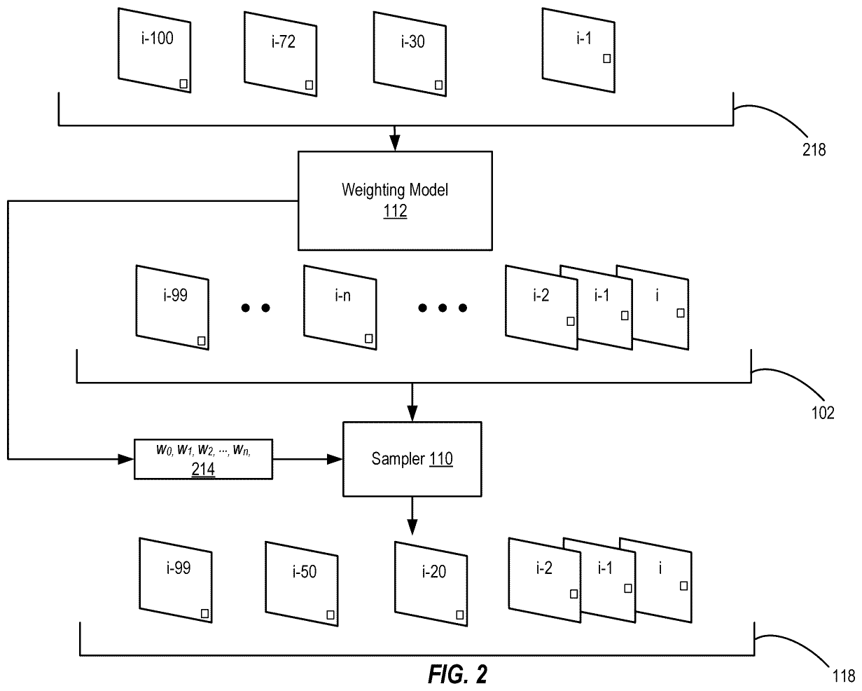

FIG. 2 depicts additional details of an adaptive sampling technique that may be employed to sample frames, such as for object tracking system 100 of FIG. 1. In particular, sampler 110 of FIG. 1 may be configured to utilize a weight based sampling technique. For example, sampler 110 may be configured to utilize weights 214 to sample frames 102 of FIG. 1 to generate at least some of the plurality of sampled frames 118 of FIG. 1. In certain aspects, the weights 214 can be utilized to construct a probability distribution, such as a multimodal Gaussian distribution, where the modes may correspond to frames with higher weights. Sampler 110 may use the probability distribution to prioritize the selection of informative frames while still maintaining some randomness to explore diverse scenarios. Additional details of an example of the use of the weights 214 to sample the frames 102 to generate the plurality of sampled frames 118 are discussed with respect to FIG. 4.

In certain aspects, the weights 214 used by sampler 110 for sampling frames 102 may be generated based on a previous plurality of sampled frames 218. For example, object tracking system 100 of FIG. 1 may be iteratively used on subsequent sets of frames to perform object tracking. As new frames enter the frame buffer, old frames are removed, and the frame buffer includes a new set of frames. For example, at time i, the frame buffer may include frames i to i-99, where i may represent the most recent frame, and i-n represents a frame that is n frames (e.g., n time intervals) prior to the most recent frame. Further, at time i+1, the frame buffer may include frames i-1 to i-98. Further, at time i−1, the frame buffer may include frames i-1 to i-100. Accordingly, the frames 102 may include frames i to i-99, and a previous plurality of frames may include frames i-1 to i-100. The previous plurality of sampled frames 218 may be a subset of the previous plurality of frames, such as based on one or more sampling techniques discussed herein. The previous plurality of sampled frames 218 may be input, for example, into weighting model 112 of FIG. 1, to generate the weights 214.

In certain aspects, the weights used by sampler 110 for sampling frames may be initialized to some values, such as for a first iteration of frames to be sampled.

In some aspects, the adaptive sampling technique in the object tracking system 100 may be applied iteratively, updating the weights 214 based on the tracking results and the feedback from the object tracking model 120. An iterative refinement may allow the object tracking system 100 to adapt to changes in the scene, object appearance, or motion patterns over time, ensuring consistent and accurate tracking performance.

In certain aspects, an adaptive sampling technique provides several advantages over traditional fixed sampling approaches. By dynamically selecting informative frames and adjusting the sampling strategy based on learned weights, the object tracking system 100 may better handle challenging scenarios, such as occlusions, clutter, or abrupt motion changes. The adaptive nature of the sampling process may enable the object tracking system 100 to allocate computational resources more efficiently, focusing on the most relevant frames while maintaining real-time performance. Moreover, in some aspects, the adaptive sampling technique can be extended to incorporate additional cues or modalities, such as depth information from LIDAR or stereo cameras, to further enhance the selection of informative frames. The weights can be learned jointly across multiple modalities, leveraging the complementary information provided by different sensors to improve tracking robustness and accuracy.

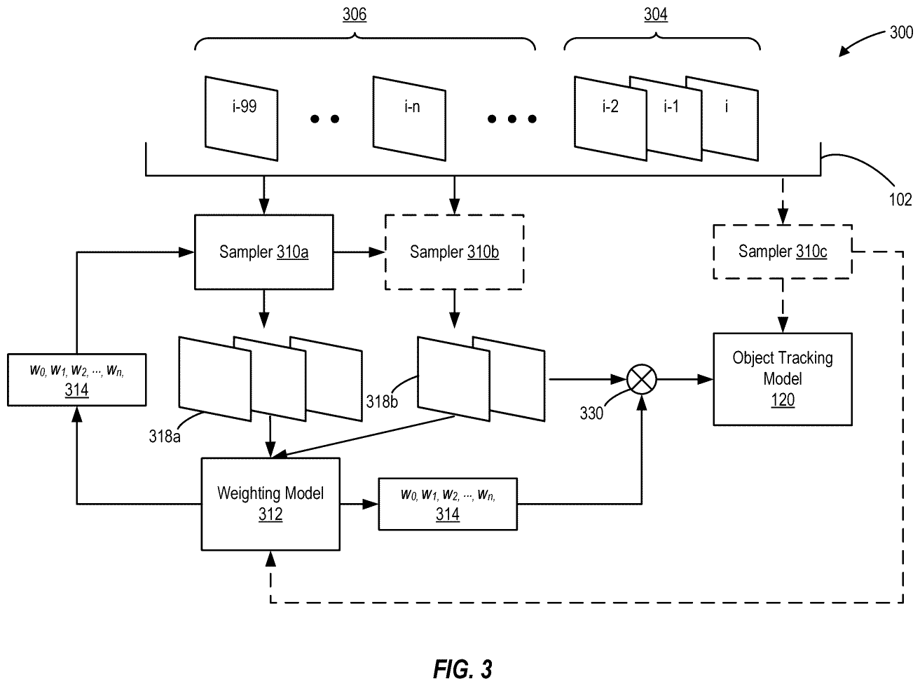

FIG. 3 depicts additional details of an example object tracking system 300 that may employ multiple sampling techniques, including an adaptive sampling technique and a weighting model to track one or more objects across a plurality of frames. Object tracking system 300 may be configured to utilize a number of sampling techniques for providing frames to the object tracking model 120 to track one or more objects, such as in the plurality of frames 102.

As shown, the plurality of frames 102, in this example, may be defined as portions, a first portion of frames 304, and a second portion of frames 306. In certain aspects, the first portion of frames 304 may be sampled from the plurality of frames 102 using a nearest neighbor sampling, whereby the latest k frames (e.g., 3 frames, 4 frames, etc.) in time of the plurality of frames 102 are sampled to be included in the plurality of sampled frames 118 provided to the object tracking model 120 for object tracking, such as discussed with respect to FIG. 1. In certain aspects, the first portion of frames 304 may not be weighted frames. For example, an optional sampler 310c may be used to perform nearest neighbor sampling of the plurality of frames 102 to select the first portion of frames 304. It should be noted that though samplers 310a-310c (e.g., corresponding to sampler 110 of FIG. 1) are shown as separate samplers, they may be a single sampler or component. In certain aspects, nearest neighbor sampling may not be used, and the first portion of frames 304 frames may not necessarily be included in the plurality of sampled frames 118.

In certain aspects, the second portion of frames 306 includes all of the plurality of frames 102 optionally minus the first portion of frames 304 (if any depending on whether nearest neighbor sampling is used) (e.g., to avoid duplicate selection of the same frame by multiple sampling techniques). In certain aspects, the second portion of frames 306 is input into a sampler 310a configured to perform adaptive sampling, such as discussed with respect to FIG. 2. Sampler 310a may output a set of frames 318a, which, in certain aspects, may be included in the plurality of sampled frames 118 provided to the object tracking model 120 for object tracking. Accordingly, the set of frames 318a may correspond to adaptively sampled frames from the plurality of frames 102. As discussed, sampler 310a may perform the adaptive sampling of the second portion of frames 306 based on weights (not shown), which may correspond to weights derived from a previous set of sampled frames, as previously discussed with respect to FIG. 2.

Optionally, in certain aspects, sampler 310b is configured to perform random sampling, such as discussed with respect to FIG. 1. For example, the second portion of frames 306 and an indication (e.g., index value(s)) of the set of frames 318a (or the frames themselves) are input into sampler 310b. Accordingly, the sampler 310b may randomly sample frames from a set of frames corresponding to the second portion of frames 306 optionally minus the set of frames 318a (e.g., to avoid duplicate selection of the same frame by multiple sampling techniques) to generate the set of frames 318b. In certain aspects, the set of frames 318b may be included in the plurality of sampled frames 118 provided to the object tracking model 120 for object tracking. Accordingly, the set of frames 318b may correspond to randomly sampled frames from the plurality of frames 102.

In certain aspects, the set of frames 318a, and optionally the set of frames 318b, are input into weighting model 312 (e.g., corresponding to weighting model 112 of FIG. 1), which is configured to generate weights 314 corresponding to the frames, as discussed herein. In certain aspects, the weights 314 are input into sampler 310a, to be used for adaptive sampling of a subsequent plurality of frames.

In certain aspects, the weights 314 are applied to the set of frames 318a, and optionally the set of frames 318b, such as by element-wise multiplication of the frames with their corresponding weights 314. Accordingly, in some aspects weighted set of frames 318a, and optionally weighted set of frames 318b, are included in the plurality of sampled frames 118 provided to the object tracking model 120 for object tracking.

For example, in certain aspects, combiner 330 may be configured to apply weights 314 to the set of frames 318a, and optionally the set of frames 318b. The combiner 330 may perform a weighted sum operation, where each frame input into combiner 330 may be multiplied by its associated weight from the weights 314, and the resulting products may be summed up to obtain the weighted frames.

In certain aspects, the combiner 330 may be implemented using one or more of various techniques, such as matrix multiplication, element-wise multiplication, or specialized hardware accelerator(s). The choice of implementation may depend on the specific requirements of the application, the available computational resources, and the desired performance characteristics. In some aspects, the combiner 330 works to ensure that the informative frames are given more importance in the object tracking process, while the less relevant frames have a reduced impact.

The weighted frames may provide more importance to the informative frames that are used for accurate object tracking, while reducing the influence of less relevant frames. The weighted frames may serve as input to the object tracking model 120, which may use them to estimate the object's identity and location.

Accordingly, object tracking model 120 may be provided a plurality of sampled frames 118, based on frames 102, to perform object tracking of one or more objects in frames 102. As discussed in the example, the plurality of sampled frames 118 may include adaptively sampled frames 318a (e.g., weighted or not), optionally randomly sampled frames 318b (e.g., weighted or not), and optionally nearest neighbor sampled frames 304 (e.g., weighted or not, as they may be similarly based as input to weighting model 312 in some aspects).

In certain aspects, the adaptive sampling may intelligently select frames based on their importance and relevance to the object tracking task, while the random sampling may choose frames randomly from the plurality of frames 102. In certain aspects, the use of a sampling mode (e.g., which sampler(s) 310a-310c to use) can be based on factors such as the complexity of the scene, the object's motion characteristics, and the available computational resources.

In some aspects, the neighbor sampled frames 304 are adjacent in time and provide local temporal context for object tracking. These frames may be separated by a fixed time interval and capture the short-term motion and appearance changes of the objects being tracked.

In certain aspects, the number of neighbor sampled frames 304 may be adjusted based on the specific requirements of the application, the complexity of the scene, and the available computational resources. A larger number of neighboring frames can provide more temporal context but may increase computational complexity, while a smaller number of neighboring frames can reduce processing time but may limit the ability to capture long-term object behavior.

In certain aspects, the use of randomly sampled frames 318b helps to ensure that the weighting model does not get stuck on local maxima or minima, and allows for more dynamic optimization of the weights. In some aspects, the use of randomly sampled frames 318b in addition to the adaptively sampled frames 318a helps to introduce diversity and exploration in the optimization of the weights by the weighting model 112. That is, by including randomly sampled frames, the weighting model 112 may be exposed to a wider range of frame variations and object appearances. This may help prevent the weighting model from getting stuck in local maxima or minima, where the weights might be optimized for a specific subset of frames but fail to generalize well to unseen data. In certain aspects, the random frames may encourage the weighting model 112 to learn more robust and diverse weights.

By including randomly sampled frames, the weighting model may explore frames that might not be selected by the adaptive sampling strategy alone. These randomly sampled frames may contain information that contributes to improved object tracking performance. By considering these frames, the weighting model 112 can potentially discover new patterns and features that enhance its ability to assign appropriate weights.

Further, the inclusion of randomly sampled frames may help to improve the generalization capability of the weighting model 112. In some aspects, by learning from a mix of adaptively and randomly sampled frames, the weighting model may become more resilient to variations and noise in the input data. This ability may allow the weighting model 112 to assign weights to frames even in novel or unseen scenarios.

FIG. 4 depicts details of an example process 400 for sampling frames from a distribution and creating a new distribution based on the previously sampled frames in accordance with aspects of the present disclosure. For example, process 400 (or at least portions thereof) may be applied by weighting model 112 or 312 and/or sampler 110 or 310a, as discussed. In certain aspects, process 400 enables adaptive sampling of frames for object tracking, allowing the system to focus on informative and relevant frames while incorporating randomness to explore diverse scenarios. In certain aspects, the initial distribution 402 represents a probability distribution from which frames are sampled for object tracking. In some examples, the initial distribution 402 may be a multimodal distribution, including multiple modes 404A-404D.

The modes 404A-404D of the initial distribution 402 can be determined based on one or more of various factors, such as historical data, domain knowledge, or heuristics. For instance, the modes may represent different object categories, motion patterns, or scene contexts that may be likely to contain informative frames for tracking. In certain aspects, by incorporating multiple modes, the initial distribution 402 allows for a more comprehensive representation of the frame space and enables adaptive sampling based on the characteristics of the frames. In some examples, the modes 404A-404D of the initial distribution 402 may be randomly selected and/or selected based on a starting interval between modes.

In some aspects, the sampling step 406 (e.g., performed by sampler 110/310a) may involve selecting frames from the plurality of frames 102 (e.g., second portion of frames 306) according to the initial distribution 402. In certain aspects, the sampling step 406 may use techniques such as probability sampling or importance sampling to draw frames from the initial distribution 402. That is, the probability of selecting a frame may be proportional to its corresponding probability in the initial distribution 402. In certain aspects, the sampling step 406 aims to select a subset of frames that are representative of the initial distribution 402. The sampled frames 408A-408E may represent the frames selected from the plurality of frames 102 during the sampling step 406. In some aspects, the sampled frames 408A-408C and 408E correspond to the modes 404A-404D of the initial distribution 402, respectively. Accordingly, these frames may be selected based on their probability in the initial distribution and are likely to contain informative content for object tracking.

In addition to the frames 408A-408C and 408E sampled from the initial distribution 402, the sampled frames may also include one or more randomly sampled frames 408D as discussed. In some aspects, the randomly sampled frame 408D may introduce an element of exploration and diversity in the sampling process. By including a random frame, the object tracking system may potentially discover new or unexpected patterns that may not be captured by the initial distribution alone. In certain aspects, the randomly sampled frame 408D allows the system to adapt to changing object behaviors or environmental conditions.

In some aspects, the determined weights 410 (e.g., determined by weighting model 112/312 based on frames 408 input into weighting model 112/312) may represent the importance or relevance assigned to each sampled frame 408A-408E. In certain aspects, these weights may be determined based on the characteristics of the sampled frames and their potential contribution to object tracking.

In certain aspects, the new multimodal distribution 412 may represent an updated probability distribution based on the determined weights 410 of the sampled frames 408A-408E. In certain aspects, weighting model 112 or 312 and/or sampler 110 or 310a, or another component, may be configured to generate new multimodal distribution 412 based on the determined weights 410. In some aspects, the new multimodal distribution 412 may include multiple modes 414A-414E, each mode corresponding to a specific sampled frame or a group of similar frames. In certain aspects, the modes 414A-414E of the new multimodal distribution 412 may be determined based on the weights assigned to the sampled frames. For example, frames with higher weights contribute more significantly to the formation of the modes, while frames with lower weights have a lesser impact. The new multimodal distribution 412 may capture the updated importance and relevance of frames based on the information obtained from the sampled frames and their associated weights.

By creating a new multimodal distribution 412 based on the determined weights, the object tracking system may dynamically adapt its sampling strategy. In some aspects, the new multimodal distribution 412 may reflect the knowledge gained from the previous sampling step and may guide the subsequent sampling process to focus on frames that are likely to be more informative for object tracking. In some aspects, the new multimodal distribution 412 may be stored for later modification and/or adaptation. In some examples, the new multimodal distribution 412 may be based on a previous distribution and/or may be a modified version of a previous distribution.

In some aspects, the sampling step 416 (e.g., performed by sampler 110/310a) may involve selecting frames from a next or subsequent plurality of frames, as discussed, according to the new multimodal distribution 412. Similar to the sampling step 406, the sampling step 416 may use probability sampling or importance sampling techniques to draw frames from the new multimodal distribution. In certain aspects, the sampling step 416 aims to select a subset of frames that are representative of the updated importance and relevance captured by the new multimodal distribution 412. By sampling frames according to the new multimodal distribution 412, the object tracking system can adapt its focus based on the information obtained from the previous sampling step. This adaptive sampling approach allows the system to progressively refine its selection of frames and improve tracking performance.

In some aspects, the sampled frames 418A-418E may represent the frames selected from the subsequent plurality of frames during the sampling step 416. In some aspects, the sampled frames 418A-418D may correspond to the modes 414A-414E of the new multimodal distribution 412, respectively. These frames may be selected based on their probability in the new distribution and are likely to contain informative content for object tracking based on the updated weights. Similar to the previous sampling step 406, in some aspects, the sampled frames may also include one or more randomly sampled frames 418E. The randomly sampled frame 418E may introduce an element of exploration and diversity in the sampling process, allowing the object tracking system to discover new or unexpected patterns that may not be captured by the new multimodal distribution alone.

In some aspects, the determined weights 420 (e.g., determined by weighting model 112/312 based on frames 408 input into weighting model 112/312) may represent the updated importance or relevance assigned to each sampled frame 418A-418E based on the new multimodal distribution 412.

In certain aspects, the adaptive sampling approach discussed in FIG. 4 allows the object tracking system to dynamically focus on informative and relevant frames while incorporating randomness for exploration. By iteratively updating the sampling distribution based on the determined weights, the object tracking system can progressively refine its selection of frames and improve tracking performance.

### Example Artificial Intelligence System for Adaptive Sampling and Object Detection

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

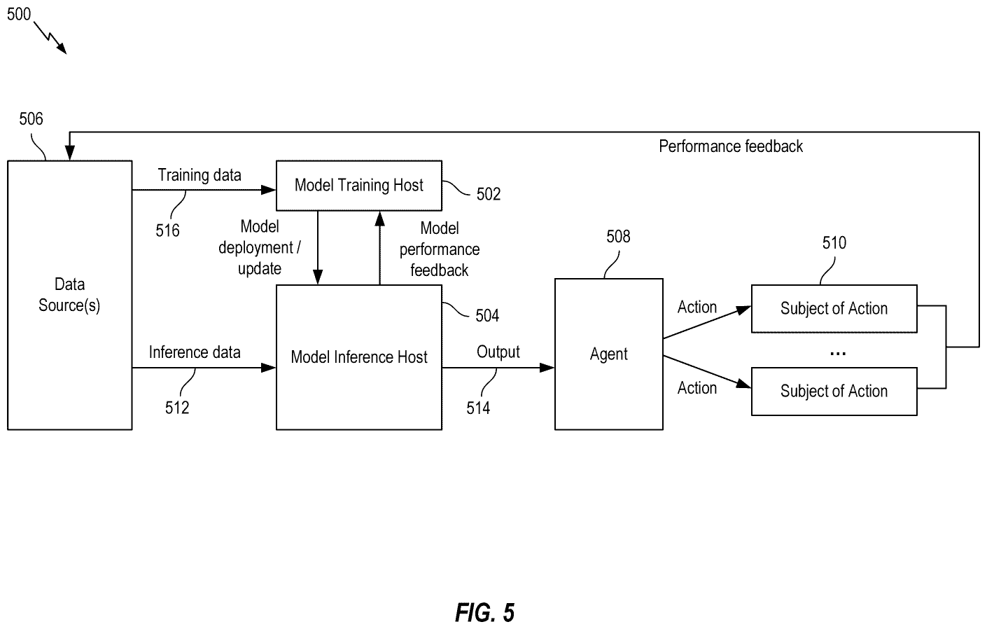

FIG. 5 is a diagram illustrating an example AI architecture 500 that may be used to implement the machine learning models and adaptive sampling techniques described in this disclosure. As illustrated, the architecture 500 includes multiple logical entities, such as a model training host 502 for training the machine learning model with adaptive sampling and weighting strategies, a model inference host 504 for running inference using the trained model, data source(s) 506 providing training and inference data, and an agent 508 that utilizes the model's output. This AI architecture could be used to enable the example disclosed adaptive sampling techniques in various machine learning applications for object detection.

The model inference host 504, in the architecture 500, is configured to run an ML model based on inference data 512 provided by data source(s) 506. The model inference host 504 may produce an output 514 (e.g., predicted object identities and locations) based on the inference data 512, that is then provided as input to the agent 508.

The agent 508 may be an element or entity that utilizes the output of the machine learning model hosted by the model inference host 504. The agent 508 could be a software component, a hardware accelerator, or a system that leverages the object detection results produced by the model for various downstream tasks such as autonomous driving, surveillance, or robotics.

For example, if the output 514 from the model inference host 504 is a set of bounding boxes and class labels for detected objects in a video frame, the agent 508 may be an autonomous vehicle control system that uses the object detection information for navigation and obstacle avoidance. As another example, if the output 514 is a count of people in a surveillance video, the agent 508 could be a security monitoring application.

After receiving the output 514 from the model inference host 504, the agent 508 may determine how to utilize it. For instance, if the agent 508 is an autonomous driving system and the output is a set of detected vehicles and pedestrians, it may use this information to plan a safe trajectory. If the agent 508 decides to use the output 514, it may apply it to the subject of the action 510, which represents the data being processed or the system being controlled. In the autonomous driving example, the subject of action 510 would be the vehicle's motion control. In some cases, the agent 508 and subject of action 510 may be tightly integrated.

The data sources 506 may be configured to collect data used as training data 516 for the model training host 502 to train the adaptive sampling-based object detection models. The data sources 506 may also provide inference data 512 to the model inference host 504. This data could come from various entities and may include the subject of action 510. For example, for training an object detection model, the data sources 506 may collect video sequences with annotated object bounding boxes. The model training host 502 can then monitor the model's performance on this data to determine if retraining or fine-tuning with the adaptive sampling and weighting techniques is necessary to improve accuracy. In some cases, the agent 508 and the subject of action 510 are the same entity.

The data sources 506 may be configured for collecting data that is used as training data 516 for training the machine learning model with adaptive sampling, weighting, and/or object detection. The data sources 506 may also provide inference data 512 (also referred to as input data) for feeding the trained model during inference. In particular, the data sources 506 may collect data relevant to the object detection task at hand, such as video frames from cameras or sensors. This data may come from various sources, including the subject of action 510, which represents the data being processed by the model. The collected data is provided to the model training host 502 for training and fine-tuning the adaptive sampling-based model. For example, after the subject of action 510 (e.g., a video frame) is processed by the model, the output 514 (e.g., predicted object bounding boxes) may be compared to ground truth annotations to evaluate the model's performance. If the output 514 is not sufficiently accurate, this performance feedback may be used by the model training host 502 to further train the model using the disclosed adaptive sampling, weighting, and/or object detection techniques, aiming to improve its object detection accuracy. The updated model may then be deployed to the model inference host 504.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, machine learning models utilizing adaptive sampling, weighting, and/or object detection techniques are deployed at or on a computing device for enhancing the performance of object detection tasks. More specifically, a model inference host, such as model inference host 504 in FIG. 5, may be deployed at or on the computing device for running the adaptive sampling-based model and/or object detection model to improve object detection accuracy and efficiency.

In some other aspects, the adaptive sampling-enhanced machine learning model is deployed at or on an embedded system or mobile device for enabling efficient on-device object detection. More specifically, a model inference host, such as model inference host 504 in FIG. 5, may be deployed at or on the embedded system or mobile device for running the model to obtain high-quality object detection results while meeting resource constraints.

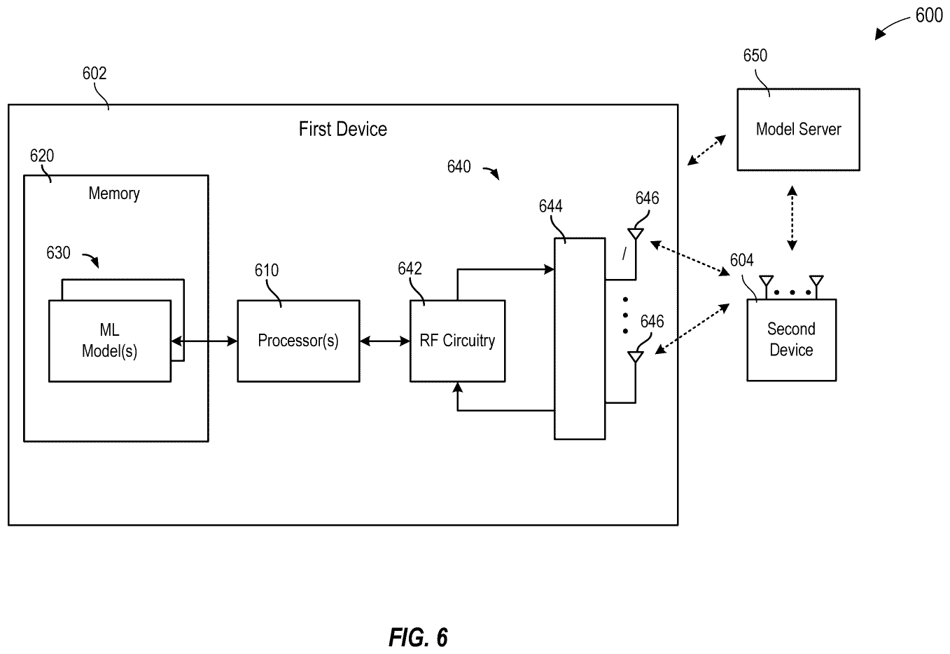

FIG. 6 illustrates an example AI architecture 600 of a first computing device 602 that is in communication with a second computing device 604. The first computing device 602 may be a server or cloud computing platform as described herein with respect to FIG. 5. Similarly, the second computing device 604 may be an embedded system or mobile device as described herein with respect to FIG. 5. Note that the AI architecture of the first computing device 602 may be applied to the second computing device 604.

The first computing device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a model inference mode, the processor 610 may transform input data (e.g., video frames) into a format suitable for the adaptive sampling-based object detection model. The processor 610 may then run the model on the formatted input data to generate output detections. The processor 610 may be coupled to a transceiver 640 for transmitting the output detections to and/or receiving input data from one or more connected devices 646. The transceiver 640 includes interface circuitry 642 and 644 for converting between the digital signals of the processor and any transmission protocol used by the connected devices 646. The connected devices 646 may be cameras, sensors, displays, or storage that provide input to or consume the output from the model.

When receiving input data via the connected devices 646 (e.g., from the second computing device 604), the transceiver interface circuitry 642 and 644 may convert the received signals to a baseband frequency and then to digital signals for processing by the processor 610. The processor 610 may format the digital input signals and feed them into the adaptive sampling-based object detection model for inference.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first computing device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may take a sequence of video frames as input and adaptively sample a subset of frames to predict object detections using one or more example adaptive sampling techniques previously described. The input data may include, for example, raw video streams from cameras or pre-processed frames. The output data may include, for example, bounding boxes and class labels for detected objects in the sampled frames, which are obtained by applying adaptive sampling, weighting, and/or object detection within the model. In certain aspects, the output detections may be considered “virtual” results in that they are not directly measured but rather inferred by the model based on the sampled observations and the learned object appearance and motion patterns. In other cases, the output detections may correspond to physical objects that are measurable in principle but not directly observed by the sensors available to the system due to occlusions or limited field of view. Note that other input data and/or output data may be used in addition to or instead of the examples described herein, depending on the specific object detection task and the available sensors.

In certain aspects, a model server 650 may perform any of various ML model lifecycle management (LCM) tasks for the first computing device 602 and/or the second computing device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first computing device 602 and/or the second computing device 604 to download.

In some cases, the model server 650 may monitor and evaluate the performance of the ML model 630 that utilizes adaptive sampling, weighting, and/or object detection to trigger one or more lifecycle management (LCM) tasks. For example, the model server 650 may determine whether to activate or deactivate the use of a particular adaptive sampling-based model at the first computing device 602 and/or the second computing device 604, based on factors such as the accuracy requirements, computational budget, and energy constraints of each device. The model server 650 may then provide instructions to the respective devices to manage their model usage accordingly. In some cases, the model server 650 may determine whether to switch to a different variant of the adaptive sampling-enhanced ML model 630 at the first computing device 602 and/or the second computing device 604, based on changes in the operating conditions or performance objectives. For instance, the model server may instruct a device to switch from a complex model with high accuracy to a simpler model with lower latency when the battery level falls below a threshold. In yet further examples, the model server 650 may act as a central coordinator for collaborative learning of adaptive sampling-based models across multiple devices, using techniques such as federated learning to train a global model from locally-computed updates while preserving data privacy.

### Example Artificial Intelligence Model

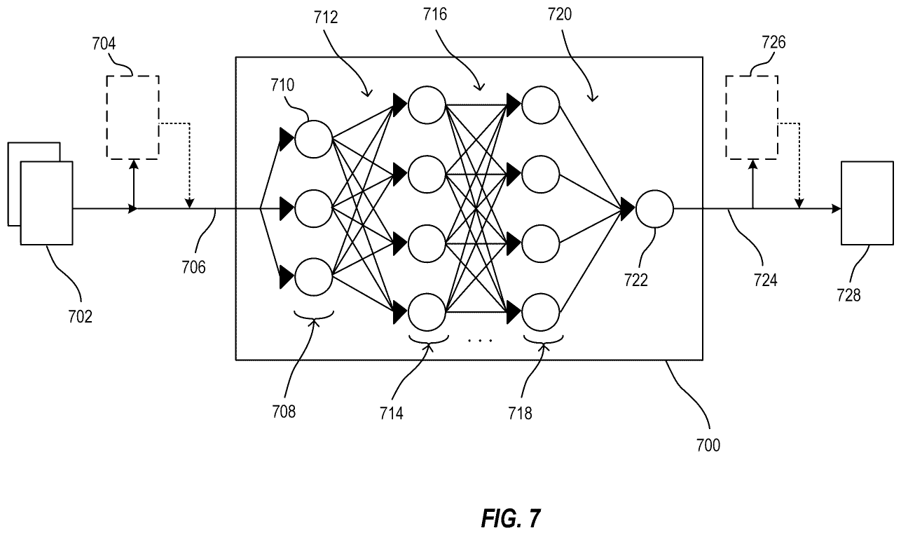

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 512 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models. In the context of adaptive sampling and object detection, a GAN can be used to generate realistic video sequences with annotated object bounding boxes, which can then be used to train the adaptive sampling-based object detection model.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing. In the context of adaptive sampling and object detection, a transformer can be used to model the temporal dependencies between frames and learn to attend to the most informative regions for accurate object tracking.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of the development process for machine learning models that perform adaptive sampling and object detection, relevant training data must be gathered or generated. For example, training data may include video sequences with annotated object bounding boxes and identities, as well as corresponding frame-level importance weights. This data can be used to train the model to accurately sample informative frames and detect objects in the selected frames. In certain instances, the training data may originate from sensors on user devices (e.g., smartphones, robots, vehicles), dedicated data collection equipment (e.g., surveillance cameras, dash cams), or public datasets. In some cases, the training data may be aggregated from multiple sources to cover a wide range of scenarios and improve model generalization. For example, crowdsourcing platforms or online databases may be leveraged to gather diverse examples for training adaptive sampling-based models. In another example, training data may be generated synthetically using simulation engines or generative models to augment real-world samples. The training data collection process can be performed offline, resulting in a static dataset for batch training, or online, where new samples are continuously incorporated into the model training pipeline. For example, an embedded system may periodically upload new training samples gathered during operation to a server, which then fine-tunes the adaptive sampling-enhanced model using online learning techniques. For offline training, data collection and model updates can occur at a central location (e.g., a datacenter) or be distributed across multiple nodes (e.g., a sensor network). For online training, the model may be adapted locally on each device or by a remote server that receives streaming data from the devices.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. For adaptive sampling and object detection models, the validation set may consist of video sequences with annotated object bounding boxes and identities that were not seen during training. The quality of the object detection results can be assessed using various metrics such as mean average precision (mAP), which measures the accuracy of the predicted bounding boxes and class labels, and multiple object tracking accuracy (MOTA), which measures the accuracy of the object identities across frames. These metrics may provide a comprehensive evaluation of the model's ability to select informative frames and accurately detect and track objects. If the model's performance is deemed unsatisfactory based on these evaluations, further fine-tuning or architectural modifications may be necessary. This may involve adjusting hyperparameters, training for more iterations, using a different loss function, or exploring alternative model architectures that are better suited for adaptive sampling and object detection tasks. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information. For adaptive sampling and object detection models, data augmentation techniques such as random cropping, flipping, rotation, scaling, and color jittering can be applied to the training video frames to increase the diversity of the data and improve the model's robustness to variations in object appearance and motion.

A transfer learning technique may be used which involves using a pre-trained model as a starting point for training a new model, which may be useful when training data is limited or when there are multiple tasks that are related to each other. For example, an object detection model pre-trained on a large dataset of images can be fine-tuned on a smaller dataset of video sequences for the adaptive sampling task, leveraging the learned features and reducing the amount of training data required.

A multi-task learning technique may be used which involves training a model to perform multiple tasks simultaneously to potentially improve the performance of the model on one or more of the tasks. For adaptive sampling and object detection, a model can be trained to jointly perform frame selection, object detection, and object tracking, allowing the model to learn shared representations and benefit from the complementary information provided by each task. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training of machine learning models that perform adaptive sampling and object detection on data distributed across multiple devices or organizations, without the need to centralize the data or the training process. Federated learning is particularly useful when the training data is sensitive or subject to privacy constraints, or when it is impractical, inefficient, or expensive to gather all the data in one place. In the context of object detection and tracking, for example, federated learning may be used to improve model performance by allowing it to learn from a wide range of environments and conditions. For instance, an adaptive sampling-based object detection model may be trained on data collected from a large number of smartphones or surveillance cameras, each with its own camera configuration and/or video characteristics and deployment settings, to improve its robustness and generalization. With federated learning, each device may receive a copy of the model and perform local training using its own data to capture device-specific patterns. The devices then send only the updated model parameters (e.g., weights and biases) to a central server, without revealing the raw video data. The server aggregates the contributions from all devices and updates the global model, which is then redistributed to the devices for the next round of local training. This process is repeated iteratively until the adaptive sampling-enhanced model achieves satisfactory performance across all participating devices. By enabling collaborative learning while keeping data localized, federated learning allows the development of powerful adaptive sampling-based models that can leverage diverse datasets without compromising privacy or security.

In some implementations, one or more devices or services may support processes relating to the usage, maintenance, activation, and reporting of machine learning models that perform adaptive sampling and object detection. In certain instances, all or part of the training data or the trained model may be shared across multiple devices to provide or improve the object detection capabilities. For example, a smartphone with a high-resolution camera may share its data with a smartphone having a lower-resolution camera, enabling the latter to train an object detection model using adaptive sampling guidance. In some cases, signaling mechanisms may be employed to communicate the capabilities and requirements for performing specific functions related to adaptive sampling-enhanced models, such as the supported input and output formats, the available computational resources, or the ability to collect and share training data. These models may be used to support various applications, such as video surveillance, autonomous driving, robotics, or augmented reality, where accurate and efficient detection and tracking of objects is crucial. The deployment of adaptive sampling-guided models may occur at different levels of a system architecture, such as on individual devices (e.g., smartphones, cameras), edge servers (e.g., base stations, gateways), or cloud platforms, depending on factors such as latency requirements, data privacy concerns, and resource availability. By leveraging the disclosed adaptive sampling techniques, these models can provide high-quality object detection results while operating under the constraints of each deployment scenario.

### Example Operations Performing Object Detection

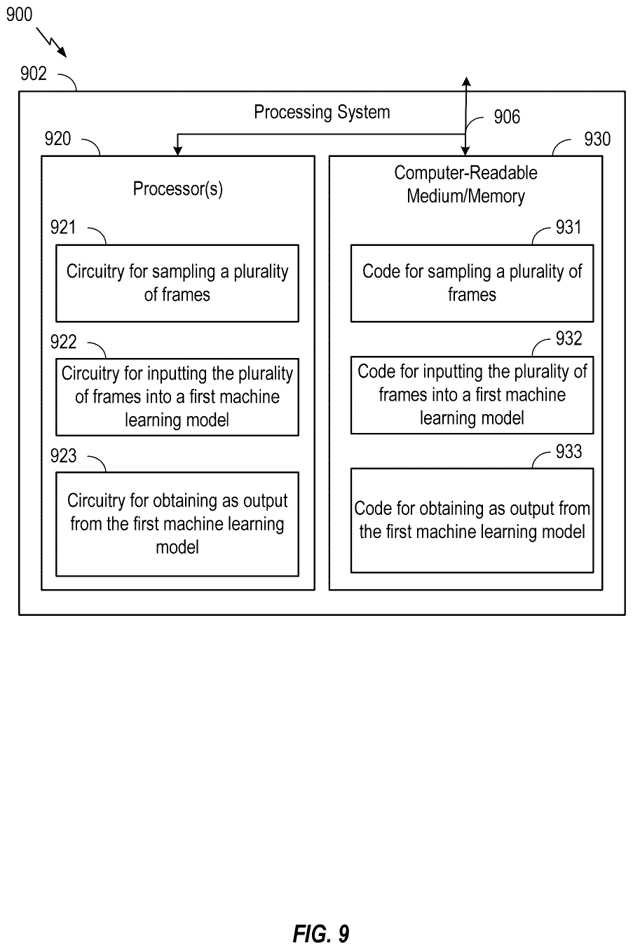

In one aspect, method 800, or any aspect related to it, may be performed by an apparatus, such as processing system 900 of FIG. 9, which includes various components operable, configured, or adapted to perform the method 800.

Method 800 beings at block 802 with sampling a plurality of frames from the sequence of frames, wherein at least two pairs of frames that are adjacent in time in the plurality of frames are separated by different time intervals.

Method 800 then proceeds to block 804 with inputting the plurality of frames into a first machine learning model trained to track objects.

Method 800 then proceeds to block 806 with obtaining as output from the first machine learning model, based on the input plurality of frames, at least one of an identity or location corresponding to one or more objects in the plurality of frames.

In certain aspects, frames adjacent in time in the sequence of frames are separated by a same time interval.

In certain aspects, sampling the plurality of frames comprises sampling one or more of the plurality of frames according to a fixed function.

In certain aspects, sampling the plurality of frames comprises sampling one or more of the plurality of frames randomly.

In certain aspects, sampling the plurality of frames comprises: inputting a set of frames of the sequence of frames into a second machine learning model; and obtaining as output from the second machine learning model, based on the input set of frames of the sequence of frames, an indication of one or more of the plurality of frames.

In certain aspects, sampling the plurality of frames comprises: sampling one or more of the plurality of frames according to an initial distribution associated with a set of frames of the sequence of frames.

In certain aspects, sampling the plurality of frames comprises: sampling one or more of the plurality of frames according to a respective weight associated with each frame of a set of frames of the sequence of frames.

In certain aspects, sampling the one or more of the plurality of frames according to the respective weight associated with each frame of the set of frames comprises: generating a distribution based on the respective weight associated with each frame of the set of frames; and sampling the one or more of the plurality of frames according to the distribution.

In certain aspects, the distribution comprises a multimodal distribution.

In certain aspects, generating the distribution comprises: generating the multimodal distribution, wherein each mode of the multimodal distribution corresponds to a respective frame of the set of frames, and wherein a respective variance for each mode of the multimodal distribution is based on the respective weight for the respective frame.

In certain aspects, method 800 further includes: generating the respective weight associated with each frame of the set of frames based on a previous sample of frames of a previous sequence of frames.

In certain aspects, the sequence of frames and the previous sequence of frames share one or more frames.

In certain aspects, generating the respective weight associated with each frame of the set of frames based on the previous sample of frames of the previous sequence of frames comprises: inputting the previous sample of frames into a second machine learning model configured to output the respective weight associated with each frame of the set of frames.

In certain aspects, method 800 further includes: inputting one or more of the plurality of frames into the second machine learning model to generate one or more second weights associated with the one or more of the plurality of frames; and inputting the one or more second weights into the first machine learning model, wherein the output from the first machine learning model is based on the one or more second weights.

In certain aspects, sampling the plurality of frames comprises: sampling at least one of the plurality of frames randomly.

In certain aspects, method 800 further includes: inputting one or more of the plurality of frames into a second machine learning model to generate one or more weights associated with the one or more of the plurality of frames; and inputting the one or more weights into the first machine learning model, wherein the output from the first machine learning model is based on the one or more weights.

In certain aspects, obtaining the at least one of the identity or the location corresponding to the one or more objects in the plurality of frames comprises: tracking the one or more objects across the plurality of frames; and generating a respective trajectory for each object of the one or more objects.

In certain aspects, method 800 further includes: communicating the output from the first machine learning model via a modem coupled to one or more antennas.

In certain aspects, the modem and the one or more antennas are integrated into one of a vehicle, an extra-reality device, or a mobile device.

In certain aspects, method 800 further includes: acquiring the sequence of frames from at least one image sensor.

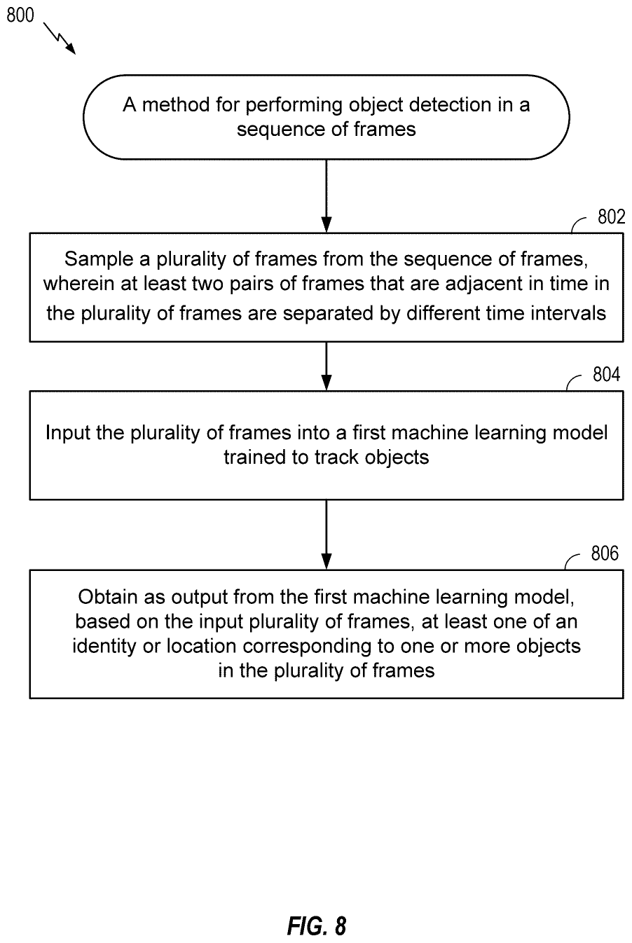

Note that FIG. 8 is just one example of a method, and other methods including fewer, additional, or alternative steps are possible consistent with this disclosure.

### Example Processing System for Performing Object Detection

FIG. 9 depicts aspects of an example processing system 900.

The processing system 900 includes a processing system 902 includes one or more processors 920. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 800 described with respect to FIG. 8, or any aspect related to it, including any additional steps or sub-steps described in relation to FIG. 8.

In the depicted example, computer-readable medium/memory 930 stores code (e.g., executable instructions) for sampling a plurality of frames 931, code for inputting the plurality of frames into a first machine learning model 932, and code for obtaining as output from the first machine learning model 933. Processing of the code 931-933 may enable and cause the processing system 900 to perform the method 800 described with respect to FIG. 8, or any aspect related to it.

The one or more processors 920 include circuitry configured to implement (e.g., execute) the code stored in the computer-readable medium/memory 930, including circuitry for sampling a plurality of frames 921, circuitry for inputting the plurality of frames into a first machine learning model 922, and circuitry for obtaining as output from the first machine learning model 923. Processing with circuitry 921-923 may enable and cause the processing system 900 to perform the method 800 described with respect to FIG. 8, or any aspect related to it.

### EXAMPLE CLAUSES

Implementation examples are described in the following numbered clauses:

Clause 1: A method for performing object detection in a sequence of frames, comprising: sampling a plurality of frames from the sequence of frames, wherein at least two pairs of frames that are adjacent in time in the plurality of frames are separated by different time intervals; inputting the plurality of frames into a first machine learning model trained to track objects; and obtaining as output from the first machine learning model, based on the input plurality of frames, at least one of an identity or location corresponding to one or more objects in the plurality of frames.

Clause 2: The method of Clause 1, wherein frames adjacent in time in the sequence of frames are separated by a same time interval.

Clause 3: The method of any one of Clauses 1-2, wherein sampling the plurality of frames comprises sampling one or more of the plurality of frames according to a fixed function.

Clause 4: The method of any one of Clauses 1-3, wherein sampling the plurality of frames comprises sampling one or more of the plurality of frames randomly.

Clause 5: The method of any one of Clauses 1-4, wherein sampling the plurality of frames comprises: inputting a set of frames of the sequence of frames into a second machine learning model; and obtaining as output from the second machine learning model, based on the input set of frames of the sequence of frames, an indication of one or more of the plurality of frames.

Clause 6: The method of any one of Clauses 1-5, wherein sampling the plurality of frames comprises: sampling one or more of the plurality of frames according to an initial distribution associated with a set of frames of the sequence of frames.

Clause 7: The method of any one of Clauses 1-6, wherein sampling the plurality of frames comprises: sampling one or more of the plurality of frames according to a respective weight associated with each frame of a set of frames of the sequence of frames.

Clause 8: The method of Clause 7, wherein sampling the one or more of the plurality of frames according to the respective weight associated with each frame of the set of frames comprises: generating a distribution based on the respective weight associated with each frame of the set of frames; and sampling the one or more of the plurality of frames according to the distribution.

Clause 9: The method of Clause 8, wherein the distribution comprises a multimodal distribution.

Clause 10: The method of Clause 9, wherein generating the distribution comprises: generating the multimodal distribution, wherein each mode of the multimodal distribution corresponds to a respective frame of the set of frames, and wherein a respective variance for each mode of the multimodal distribution is based on the respective weight for the respective frame.

Clause 11: The method of any one of Clauses 7-10, further comprising: generating the respective weight associated with each frame of the set of frames based on a previous sample of frames of a previous sequence of frames.

Clause 12: The method of Clause 11, wherein the sequence of frames and the previous sequence of frames share one or more frames.

Clause 13: The method of any one of Clauses 11-12, wherein generating the respective weight associated with each frame of the set of frames based on the previous sample of frames of the previous sequence of frames comprises: inputting the previous sample of frames into a second machine learning model configured to output the respective weight associated with each frame of the set of frames.

Clause 14: The method of Clause 13, further comprising: inputting one or more of the plurality of frames into the second machine learning model to generate one or more second weights associated with the one or more of the plurality of frames; and inputting the one or more second weights into the first machine learning model, wherein the output from the first machine learning model is based on the one or more second weights.

Clause 15: The method of any one of Clauses 7-14, wherein sampling the plurality of frames comprises: sampling at least one of the plurality of frames randomly.

Clause 16: The method of any one of Clauses 1-15, further comprising: inputting one or more of the plurality of frames into a second machine learning model to generate one or more weights associated with the one or more of the plurality of frames; and inputting the one or more weights into the first machine learning model, wherein the output from the first machine learning model is based on the one or more weights.

Clause 17: The method of any one of Clauses 1-16, wherein obtaining the at least one of the identity or the location corresponding to the one or more objects in the plurality of frames comprises: tracking the one or more objects across the plurality of frames; and generating a respective trajectory for each object of the one or more objects.

Clause 18: The method of any one of Clauses 1-17, further comprising communicating the output from the first machine learning model via a modem coupled to one or more antennas.

Clause 19: The method of Clause 18, wherein the modem and the one or more antennas are integrated into one of a vehicle, an extra-reality device, or a mobile device.

Clause 20: The method of any one of Clauses 1-14, further comprising acquiring the sequence of frames from at least one image sensor.

Clause 21: One or more apparatuses, comprising: one or more memories comprising executable instructions; and one or more processors configured to execute the executable instructions and cause the one or more apparatuses to perform a method in accordance with any one of clauses 1-20.

Clause 22: One or more apparatuses, comprising: one or more memories; and one or more processors, coupled to the one or more memories, configured to cause the one or more apparatuses to perform a method in accordance with any one of Clauses 1-20.

Clause 23: One or more apparatuses, comprising: one or more memories; and one or more processors, coupled to the one or more memories, configured to perform a method in accordance with any one of Clauses 1-20.

Clause 24: One or more apparatuses, comprising means for performing a method in accordance with any one of Clauses 1-20.

Clause 25: One or more non-transitory computer-readable media comprising executable instructions that, when executed by one or more processors of one or more apparatuses, cause the one or more apparatuses to perform a method in accordance with any one of Clauses 1-20.

Clause 26: One or more computer program products embodied on one or more computer-readable storage media comprising code for performing a method in accordance with any one of Clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more. ” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more. ” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured to perform object detection in a sequence of frames, comprising:
one or more memories configured to store the sequence of frames; and
one or more processors, coupled to the one or more memories, configured to:
sample a plurality of frames from the sequence of frames, wherein at least two pairs of frames that are adjacent in time in the plurality of frames are separated by different time intervals;
input the plurality of frames into a first machine learning model trained to track objects; and
obtain as output from the first machine learning model, based on the input plurality of frames, at least one of an identity or location
corresponding to one or more objects in the plurality of frames.

2. The apparatus of claim 1, wherein frames adjacent in time in the sequence of frames are separated by a same time interval.

3. The apparatus of claim 1, wherein to sample the plurality of frames comprises to sample one or more of the plurality of frames according to a fixed function.

4. The apparatus of claim 1, wherein to sample the plurality of frames comprises to sample one or more of the plurality of frames randomly.

5. The apparatus of claim 1, wherein to sample the plurality of frames comprises to:
input a set of frames of the sequence of frames into a second machine learning model; and
obtain as output from the second machine learning model, based on the input set of frames of the sequence of frames, an indication of one or more of the plurality of frames.

6. The apparatus of claim 1, wherein to sample the plurality of frames comprises to:
sample one or more of the plurality of frames according to an initial distribution associated with a set of frames of the sequence of frames.

7. The apparatus of claim 1, wherein to sample the plurality of frames comprises to:
sample one or more of the plurality of frames according to a respective weight associated with each frame of a set of frames of the sequence of frames.

8. The apparatus of claim 7, wherein to sample the one or more of the plurality of frames according to the respective weight associated with each frame of the set of frames comprises to:
generate a distribution based on the respective weight associated with each frame of the set of frames; and
sample the one or more of the plurality of frames according to the distribution.

9. The apparatus of claim 8, wherein the distribution comprises a multimodal distribution.

10. The apparatus of claim 9, wherein to generate the distribution comprises to:
generate the multimodal distribution, wherein each mode of the multimodal distribution corresponds to a respective frame of the set of frames, and wherein a respective variance for each mode of the multimodal distribution is based on the respective weight for the respective frame.

11. The apparatus of claim 7, wherein the one or more processors are further configured to:
generate the respective weight associated with each frame of the set of frames based on a previous sample of frames of a previous sequence of frames.

12. The apparatus of claim 11, wherein the sequence of frames and the previous sequence of frames share one or more frames.

13. The apparatus of claim 11, wherein to generate the respective weight associated with each frame of the set of frames based on the previous sample of frames of the previous sequence of frames comprises to:
input the previous sample of frames into a second machine learning model configured to output the respective weight associated with each frame of the set of frames.

14. The apparatus of claim 13, wherein the one or more processors are further configured to:
input one or more of the plurality of frames into the second machine learning model to generate one or more second weights associated with the one or more of the plurality of frames; and
input the one or more second weights into the first machine learning model, wherein the output from the first machine learning model is based on the one or more second weights.

15. The apparatus of claim 7, wherein to sample the plurality of frames comprises to:
sample at least one of the plurality of frames randomly.

16. The apparatus of claim 1, wherein the one or more processors are further configured to:
input one or more of the plurality of frames into a second machine learning model to generate one or more weights associated with the one or more of the plurality of frames; and
input the one or more weights into the first machine learning model, wherein the output from the first machine learning model is based on the one or more weights.

17. The apparatus of claim 1, wherein to obtain the at least one of the identity or the location corresponding to the one or more objects in the plurality of frames comprises to:
track the one or more objects across the plurality of frames; and
generate a respective trajectory for each object of the one or more objects.

18. The apparatus of claim 1, further comprising a modem, coupled to one or more antennas, and coupled to the one or more processors, wherein the modem and the one or more antennas are configured to communicate the output from the first machine learning model.

19. The apparatus of claim 18, wherein the modem and the one or more antennas are integrated into one of a vehicle, an extra-reality device, or a mobile device.

20. A method configured to perform object detection in a sequence of frames, comprising:
sampling a plurality of frames from a sequence of frames, wherein at least two pairs of frames that are adjacent in time in the plurality of frames are separated by different time intervals;
inputting the plurality of frames into a first machine learning model trained to track objects; and
obtaining as output from the first machine learning model, based on the input plurality of frames, at least one of an identity or location corresponding to one or more objects in the plurality of frames.
